(19) United States
(12) Patent Application Publication
(10) Pub. No.: US 2013/0291895 A1
(43) Pub. Date: Nov. 7, 2013

(54) DISHWASHING APPLIANCE WITH PH CONTROLLED CYCLES

(71) Applicants: Ramasamy Thiyagarajan, Louisville, KY (US); William A. Baker, Louisville, KY (US)

(72) Inventors: Ramasamy Thiyagarajan, Louisville, KY (US); William A. Baker, Louisville, KY (US)

(73) Assignee: GENERAL ELECTRIC COMPANY, Schenectady, NY (US)

(21) Appl. No.: 13/465,137

(22) Filed: May 7, 2012

(51) Int. Cl. A47L 15/46; B08B 3/08; A47L 15/44; B08B 3/02

(52) U.S. Cl. 134/18; 134/25.2; 134/103.2; 134/56 D

(57) ABSTRACT

A dishwashing appliance is provided that adjusts the pH during the cleaning process so as to allow for cleaning with both alkaline and acidic wash fluids. Alkali and acidic additives are used to improve the removal of substances that are pH sensitive. Such additives can be provided in predetermined amounts and/or a pH sensor can be used to regulate the amount of such additives that are utilized during the cleaning process.

### FIELD OF THE INVENTION

The subject matter of the present invention relates to the operation of a dishwashing appliance including pH modification of a wash fluid.

### BACKGROUND OF THE INVENTION

The cleaning process for a typical dishwashing appliance includes one or more washing, rinsing, and drying cycles. Conventionally, a wash fluid containing e.g., water and alkaline detergent is applied during a wash cycle. A rinse fluid containing e.g., water and possibly certain rinse or drying agents may be added during rinse and/or drying cycles.

During these cycles in the cleaning process, particularly during the wash cycle, a variety of different substances may be present that can have an effect on the efficacy of the cleaning process. By way of example, food present on articles such as plates, cooking utensils, cups, etc. can comprise a variety of different materials such as sugars, starches, salts, proteins, and fats. Additionally, depending upon the water supply provided to the dishwashing appliance, various calcium compounds and/or other minerals may be present as well.

Unfortunately, the solubility of these various substances in water can be affected by pH which, in turn, can have a substantial impact on the cleaning process. While sugars, some starches, and most salts may be soluble in water, proteins and fat emulsions can require a more alkaline wash fluid while certain minerals require a more acidic wash fluid before solubility or at least capture by the wash fluid can occur. As such, the efficacy of a wash fluid based solely on an alkaline detergent can be limited or even counterproductive.

In addition, with continued pressure on natural resources, appliance manufacturers typically have a continued focus on efficiency in the design and operation of their products. For dish washing appliances, the amount of electricity, detergent, and/or water used during operation is carefully scrutinized for potential opportunities for improved conservation. Challenges are presented in attempting to reduce the amount of e.g., electricity, detergent, and/or water used during the cleaning process. By way of example, a reduction in any one of these parameters of may have a deleterious impact on the overall cleanliness of the articles present in the dishwasher.

In view of problems that can include those identified above, a dishwashing appliance that can adjust pH during the cleaning process would be useful. More particularly, a dishwasher that can e.g., provide for adjustments to the pH of wash fluid(s) used during one or more cycles of the cleaning process would be beneficial. Such a dishwasher that can provide for such adjustments in a manner that can conserve one or more resources would also be useful.

### BRIEF DESCRIPTION OF THE INVENTION

The present invention provides a dishwashing appliance that adjusts the pH during the cleaning process so as to provide for cleaning with both alkaline and acidic wash fluids. Alkali and acidic additives are used to improve the removal of substances that are pH sensitive. Such additives can be provided in predetermined amounts and/or a pH sensor can be used to regulate the amount of such additives that are utilized during the cleaning process. Additional aspects and advantages of the invention will be set forth in part in the following description, or may be obvious from the description, or may be learned through practice of the invention.

In one exemplary aspect, the present invention provides a method for operating a dishwasher appliance. The method includes the steps of providing fresh water W_{B} into a wash chamber of the dishwasher appliance; dispensing an alkaline material to increase the pH of water W_{B}; spraying water W_{B} onto one or more articles in the wash chamber; removing water W_{B} from the wash chamber; providing fresh water W_{A} into the wash chamber; dispensing an acidic material to decrease the pH of water W_{A}; spraying water W_{A} onto one or more articles in the wash chamber; and removing water W_{A} from the wash chamber.

In another exemplary aspect, the present invention provides another method for operating a dishwasher appliance. This method includes the steps of providing a fresh water W_{P} into a wash chamber of the dishwasher appliance; spraying water W_{P} onto one or more articles in the wash chamber; and then measuring the turbidity of water W. If the turbidity of water W_{P} is below a certain predetermined value T_{L}, then the method also includes the steps of providing fresh water W_{B} into a wash chamber of the dishwasher appliance; dispensing an alkaline material to increase the pH of water W_{B}; spraying water W_{B} onto one or more articles in the wash chamber; removing water W_{B} from the wash chamber; providing fresh water W_{A} into the wash chamber; dispensing an acidic material to decrease the pH of water W_{A}; spraying water W_{A} onto one or more articles in the wash chamber; and removing water W_{A} from the wash chamber.

In another exemplary embodiment, the present invention provides a dishwasher appliance that includes a wash chamber and at least one spray assembly located in the wash chamber and configured for spraying fluids onto one or more articles located in the wash chamber. At least one processing device is configured for executing a basic wash cycle using a wash fluid having an alkaline pH value; executing an acid wash cycle using a wash fluid having an acidic pH value; and executing a rinse cycle using fresh water.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front view of an exemplary embodiment of a dishwashing appliance of the present invention.

FIG. 2 illustrates a cross-sectional view of the exemplary embodiment of FIG. 1.

FIGS. 3, 4, and 5 illustrate exemplary methods of the present invention.

The use of the same or similar reference numerals in the figures indicates same or similar features.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

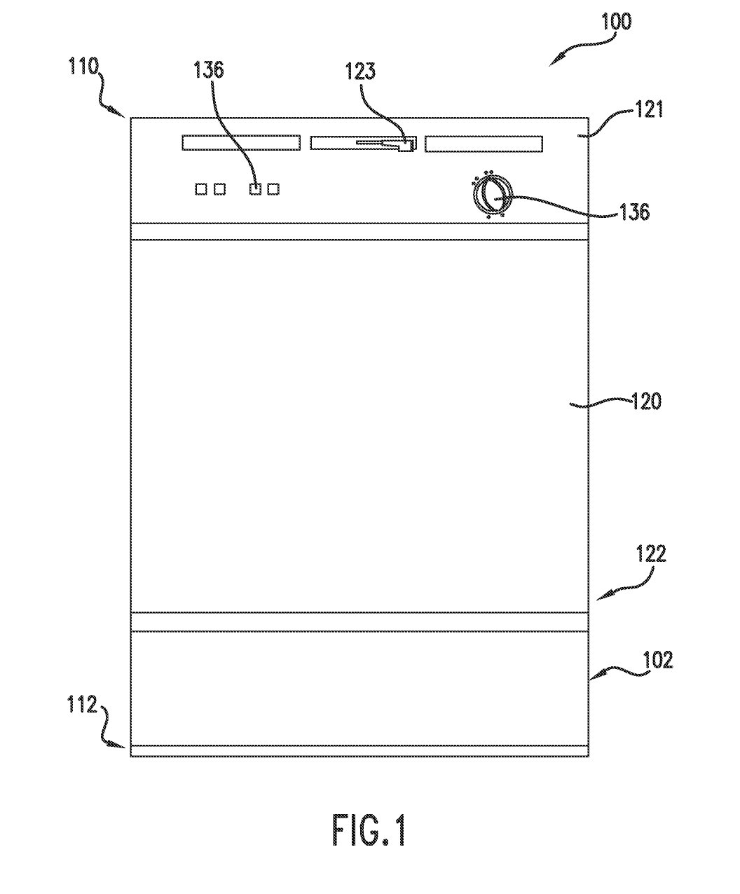

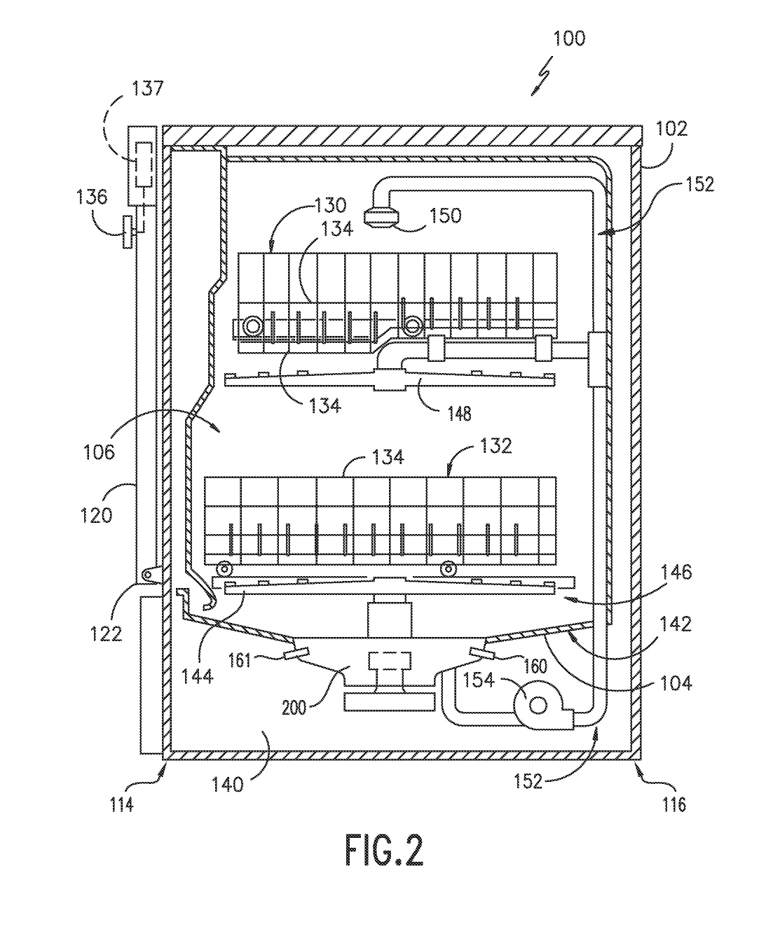

FIGS. 1 and 2 depict an exemplary domestic dishwasher appliance 100 that may be configured in accordance with aspects of the present disclosure. For the particular embodiment of FIG. 1, the dishwasher 100 includes a cabinet 102 that extends between a front 114 and a back 116. The cabinet 102 also extends between a top 110 and a bottom 112. The cabinet 102 has a tub 104 therein that defines a wash chamber 106. The tub 104 includes a front opening (not shown) and a door 120 hinged at its bottom 122 for movement between a normally closed, vertical position (shown in FIGS. 1 and 2), wherein the wash chamber 106 is sealed shut for washing operation, and a horizontal, open position for loading and unloading of articles from the dishwasher. Latch 123 is used to lock and unlock door 120 for access to chamber 106. Tub 104 also includes (e.g., defines) a sump 200 positioned adjacent bottom 112 of cabinet 102 and configured for receipt of dispensed fluids and additives (e.g., water, detergent (liquid or solid), washing fluid, rinse additives, drying additive, and/or any other suitable materials) during operation of appliance 100.

An inlet 160 is positioned adjacent sump 200 of appliance 100. Inlet 160 is configured for directing liquid into sump 200. Inlet 160 may receive liquid from, e.g., a fresh water supply (not shown) or any other suitable source. In alternative embodiments, inlet 160 may be positioned at any suitable location within appliance 100 such that inlet 160 directs liquid into tub 104. Inlet 160 may include a valve (not shown) such that liquid may be selectively directed into tub 104. Thus, for example, during the cycles described below, inlet 160 may selectively direct water and/or washing fluid into sump 200 as required by cycle of the appliance 100 and/or directed by one or more controllers or processing devices.

Rack assemblies 130 and 132 are slidably mounted within the wash chamber 106. Each of the rack assemblies 130, 132 is fabricated into lattice structures including a plurality of elongated members 134. Each rack 130, 132 is adapted for movement between an extended loading position (not shown) in which the rack is substantially positioned outside the wash chamber 106, and a retracted position (shown in FIGS. 1 and 2) in which the rack is located inside the wash chamber 106. A silverware basket (not shown) may be removably attached to rack assembly 132 for placement of silverware, utensils, and the like, that are otherwise too small to be accommodated by the racks 130, 132.

The dishwasher 100 further includes a lower spray-arm assembly 144 that is rotatably mounted within a lower region 146 of the wash chamber 106 and above a tub sump portion 142 so as to rotate in relatively close proximity to rack assembly 132. A mid-level spray-arm assembly 148 is located in an upper region of the wash chamber 106 and may be located in close proximity to upper rack 130. Additionally, an upper spray head assembly 150 may be located above the upper rack 130.

The lower and mid-level spray-arm assemblies 144, 148 and the upper spray head assembly 150 are fed by a fluid circulation assembly 152 for circulating water and dishwasher fluid in the tub 104. The fluid circulation assembly 152 may include a drain pump 154 located in a machinery compartment 140 located below the bottom sump portion 142 of the tub 104, as generally recognized in the art. Each spray-arm assembly 144, 148 includes an arrangement of discharge ports or orifices for directing fluids (e.g., water, wash fluids, rinse fluids, etc.) onto articles such as e.g., dishes, cooking utensils, silverware, and/or other articles located in rack assemblies 130 and 132. The arrangement of the discharge ports in spray-arm assemblies 144, 148 provides a rotational force by virtue of washing fluid flowing through the discharge ports. The resultant rotation of the lower spray-arm assembly 144 provides coverage of dishes and other dishwasher contents with a washing spray.

The dishwasher 100 is further equipped with a processing device or controller 137 to regulate operation of the dishwasher 100. The controller may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. By way of example, it should be understood that the processing device could include one or microprocessors and one or more memory devices.

The controller 137 may be positioned in a variety of locations throughout dishwasher 100. In the illustrated embodiment, the controller 137 may be located within a control panel area 121 of door 120 as shown. In such an embodiment, input/output (“I/O”) signals may be routed between the control system and various operational components of dishwasher 100 along wiring harnesses that may be routed through the bottom 122 of door 120. Typically, the controller 137 includes a user interface panel 136 through which a user may select various operational features and modes and monitor progress of the dishwasher 100. In one embodiment, the user interface 136 may represent a general purpose I/O (“GPIO”) device or functional block. In one embodiment, the user interface 136 may include input components, such as one or more of a variety of electrical, mechanical or electro-mechanical input devices including rotary dials, push buttons, and touch pads. The user interface 136 may include a display component, such as a digital or analog display device designed to provide operational feedback to a user. The user interface 136 may be in communication with the controller 137 via one or more signal lines or shared communication busses.

As shown, a sensing device 161 is positioned in sump 200 of the appliance 100. Sensing device 161 could be e.g., a pH sensor, turbidity sensor, or a combination thereof. In alternative embodiments, a pH sensor and/or turbidity sensor could be separately located and positioned at other locations within appliance 100. Regardless, one or more sensors or sensing devices 161 are used, for this exemplary embodiment, to provide measurements of pH, turbidity, or both to processing device 137 during operation of appliance 100. These measurements can be used by controller 137 as further described herein.

It should be appreciated that the subject matter disclosed herein is not limited to any particular style, model, or other configuration of dishwasher, and that the embodiment depicted in FIGS. 1 and 2 is for illustrative purposes only. For example, instead of the racks 130, 132 depicted in FIG. 1, the dishwasher 100 may be of a known configuration that utilizes drawers that pull out from the cabinet and are accessible from the top for loading and unloading of articles. Other configurations may be used as well.

Exemplary methods of the present invention will now be further described. For each exemplary method of the present invention, processing device 137 can be configured, for example, to operate appliance 100 according to the steps described. This may include receiving signals from other components of appliance 100 and providing instructions to one or more of the same as will be further described.

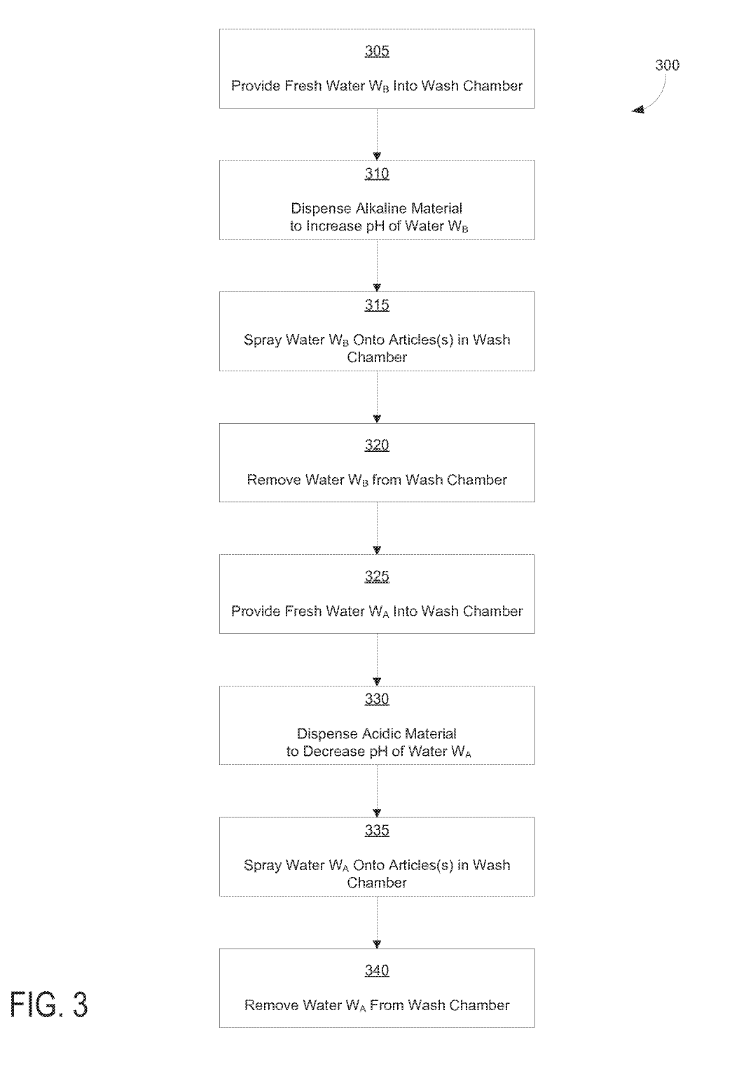

FIG. 3 illustrates an exemplary method 300 of operation of dishwashing appliance such as e.g., appliance 100. Step 305 includes providing fresh water W_{B} into a wash chamber of the dishwasher appliance. For example, processing device 137 may actuate a valve (not shown) connected to a fresh water supply in the user's home so as to fill sump 200 with a predetermined volume of water W_{B}. As used herein, “fresh water” refers to water supplied from a source external to appliance 100 such as well or municipal water supply. After filling sump 200, water W_{B} may be heated. For example, water W_{B} may be heated to a temperature of 130° F. or higher. Heating the water can e.g., provide thermal energy for cleaning and increase the solubility of alkaline materials added to water W_{B}.

Next, in step 310, an alkaline material is dispensed into water W_{B} to increase the pH of water W_{B}. The alkaline material can be provided, for example, from dispensing containers (not shown) that are located in or near appliance 100. As used herein, “alkaline materials” refers to one or more substances in solid and/or liquid form that can be used to raise the pH of water W_{B}. Examples include glycine and sodium hydroxide, borax and sodium hydroxide, carbonate-bicarbonate, and others may be used as well. The pH is raised so as to help provide a wash fluid comprised of water W_{B} and the alkaline material that will dissolve soils on articles placed in wash chamber 106 that are more soluble or only soluble in an alkaline wash fluid such as e.g., certain proteins and fats. By way of example, the pH may be raised to a level in the range of about 8 to about 12. Other ranges may be used as well.

The addition of alkaline material may be accomplished by dispensing a predetermined amount of the alkaline material into water W_{B} located in sump 200. For example, knowing the volume of water dispensed, the manufacturer could program processing device 137 to dispense a predetermined amount of the alkaline material. Alternatively, a pH sensor such as sensor 161 could be used in conjunction with sequential additions of alkaline material until the desired pH value is attained. For example, a predetermined amount of alkaline material could be added followed by operating appliance 100 in a wash cycle to spray water W_{B} onto articles in chamber 106 using spray assemblies 150, 148, and 144. Following this wash cycle, the pH could be checked using the pH sensor to determine if the desired pH level has been reached. If not, then alkaline material could be added to water W_{B} again and the process repeated until the desired pH level is obtained. Using the teachings disclosed herein, one of skill in the art will understand that other techniques may also be employed to attain the pH level desired.

Once the alkaline material has been added, in step 315 water W_{B} is sprayed onto one or more articles (such as e.g., dishes, cooking utensils, and/or silverware) placed in the wash chamber 106 or racks 130 and/or 132. For example, fluid circulation assembly 152 is operated and spray assemblies 144, 148, and 150 are operated for a time sufficient to help dissolve and/or remove materials, particularly materials soluble in water W_{B} that is now alkaline due to the dispensing of the alkaline material therein. Following step 315, water W_{B} now also contains soils from the articles including foods and other materials entrained in water W_{B} or dissolved therein. Water W_{B} is now removed or drained from the wash chamber 106 in step 320. Together, steps 305, 310, 315, and 320 (or variants thereof) can be referred to as a “basic” wash cycle in that a basic or alkaline fluid is used to wash articles in wash chamber 106.

In step 325, fresh water W_{A} is provided into the wash chamber 106. Again, such may be accomplished, for example, by using controller 137 to actuate one or more valves controlling a fresh water supply to appliance 100 so as to provide a predetermined volume of water into sump 200. After filling sump 200, water W_{A} may be heated. For example, water W_{A} may be heated to a temperature of 130° F. or higher. Heating the water can e.g., provide thermal energy for cleaning and increase the solubility of acidic materials added to water W_{A}.

Next, in step 330, an acidic is dispensed into water W_{A} to decrease the pH of water W_{A}. The acidic material can be provided, for example, from dispensing containers (not shown) that are located in or near appliance 100. As used herein, “acidic materials” refers to one or more substances in solid and/or liquid form that can be used to lower the pH of water W_{A}. Examples include citric acid, vinegar, and others may be used as well. The pH of water W_{A} is lowered so as to help provide a wash fluid comprised of water W_{A} and the acidic material that will dissolve material in water W_{A} and/or soils on articles placed in wash chamber 106 that are more soluble or only soluble in an acidic wash fluid such as e.g., certain limestones and mineral deposits. By way of example, the pH may be lowered to a level in the range of about 2 to about 5. Other ranges may be used as well.

The addition of acidic material may be accomplished by dispensing a predetermined amount of the acidic material into water W_{B} located in sump 200. For example, know the volume of water dispensed, the manufacturer could program processing device 137 to dispense a predetermined amount of the acidic material. Alternatively, a pH sensor such as sensor 161 could be used to pH measurements in conjunction with additional of acidic material until the desired pH value is attained. For example, a predetermined amount of acidic material could be added followed by operating appliance 100 in a wash cycle to spray water W_{A} onto articles in chamber 106 using spray assemblies 150, 148, and 144. Following this wash cycle, the pH could be checked using the pH sensor to determine if the desired pH level has been reached. If not, then acidic material could be added to water W_{A} again and the process repeated until the desired pH level is obtained. Using the teachings disclosed herein, one of skill in the art will understand the other techniques may also be employed to attain the pH level desired.

Once the acidic material has been added, in step 335 water W_{A} is sprayed onto one or more articles (such as e.g., dishes, cooking utensils, and/or silverware) placed in the wash chamber 106 or racks 130 and/or 132. For example, fluid circulation assembly 152 is operated and spray assemblies 144, 148, and 150 are operated for a time sufficient to help dissolve and/or remove materials, particularly materials soluble in water W_{A} that is now acidic due to the dispensing of the acidic material therein. Following step 335, water W_{A} now also contains soils from the articles including foods and other materials entrained in water W_{B} or dissolved therein. Water W_{A} is now removed or drained from the wash chamber 106 in step 320. Together, steps 325, 330, 335, and 340 (or variants thereof) can be referred to as an “acidic” wash cycle in that an acidic fluid is used to wash articles in wash chamber 106.

If desired, additional steps could be added to those shown in FIG. 3 to provide still other exemplary methods of the present invention. For example, additional rinsing steps could be provided in which another volume of fresh water W_{R} is added to wash chamber 106. Water W_{R} could then be sprayed onto articles in racks 130 and/or 132 for a time period sufficient to rinse such articles and remove soils or other residues remaining after the previously described wash steps.

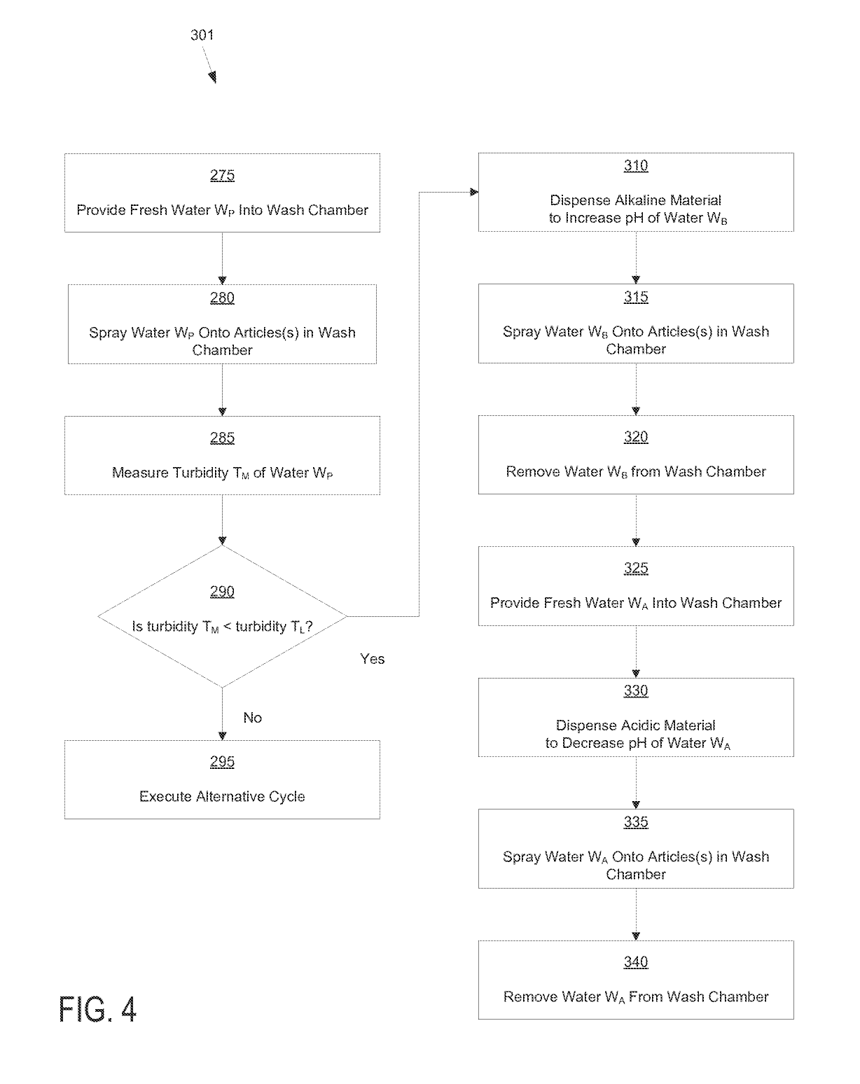

Another exemplary method 301 of the present invention is illustrated in FIG. 4. Method 301 includes part of the exemplary method 300 shown in FIG. 3 except that an initial prewash cycle with turbidity measurement has been added. More particularly, in step 275 fresh water W_{P} is added into the wash chamber 106. Next, in step 280 and for a predetermined period of time, water W_{P} is sprayed onto one or more articles in wash chamber 106 using e.g., spray assemblies 144, 148, and 150. Accordingly, step 280 provides a prewash that can be used to capture foods and other soils that may be water soluble or can be otherwise removed by water W. In step 285 the turbidity of water W_{P} is measured after or while spraying the articles for a predetermined period of time. This measurement may taken e.g., using a turbidity sensor for sensor 161 in sump 200 or in addition to sensor 161 at another location in sump 200.

In step 290, the resulting turbidity measurement T_{M} is compared with a predetermined turbidity value T_{L}. If turbidity measurement T_{M} is less than predetermined turbidity value T_{L}, then steps 310 through 340 are executed as previously described with regard to FIG. 3. If, however, turbidity measurement T_{M} is greater than predetermined turbidity value T_{L}, then an alternative cycle is executed as indicated in step 295. By way of example, alternative cycle in step 295 might include draining water W_{P} from sump 106 and repeating steps 275 through 290 until turbidity measurement T_{M} is less than predetermined turbidity value T_{L}. Such could be used as a prewash to e.g., remove heavy soils from the articles. In still another example, alternative cycle 295 might include a conventional wash cycle using an alkaline detergent. Other examples may be used as well.

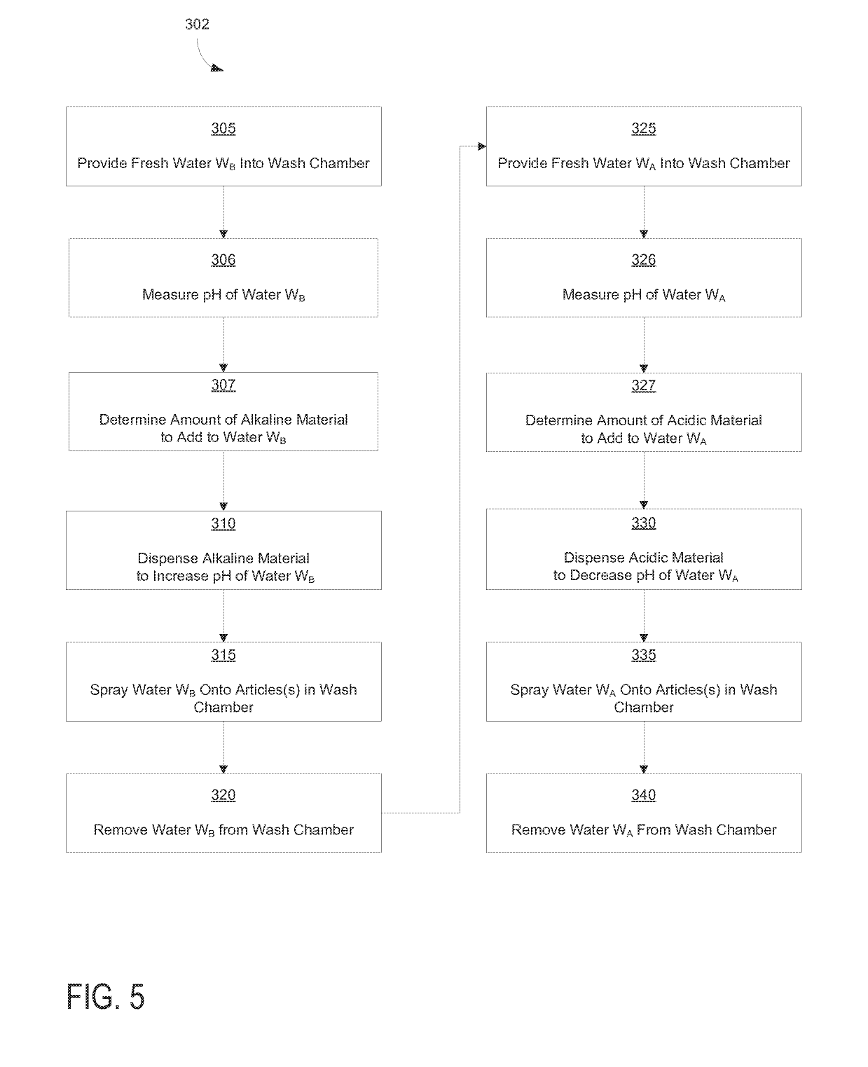

FIG. 5 illustrates still another exemplary method 302 of the present invention in which steps 305, 310, 315, 320, 325, 330, 335, and 340 are executed in a same or similar manner to that described with regard to FIG. 3 above. However, method 302 includes the use of a pH sensor (such as sensor 161 in sump 200 or another sensor in addition thereto) to provide for a determination of how much alkaline or acid material must be added to achieve the desired pH value for water in chamber 106.

More specifically, after providing fresh water W_{B} into wash chamber 106 in step 305 as previously described, the pH of water W_{B} is measured in step 306. Knowing the quantity of water W_{B} added into chamber 106, the amount of alkaline material needed to raise the pH to a desired level or range is determined in step 307. In step 310, this amount of alkaline material is added to water W_{B}, which is followed by spraying the same onto articles in chamber 106 in step 315 as previously described. After spraying for a predetermined period of time, water W_{B} is drained from wash chamber 106 in step 320.

Next, in steps 325 and 326, fresh water W_{A} is added to chamber 106 and its pH measured in a manner as previously described. Knowing the quantity of water W_{A} added into chamber 106, the amount of acidic material needed to lower the pH to a desired level or range is determined in step 327. In step 330, this amount of acidic material is added to water W_{A}, which is followed by spraying the same onto articles in chamber 106 in step 335 as previously described. After spraying for a predetermined period of time, water W_{A} is drained from wash chamber 106 in step 340.

Using the teachings disclosed herein, modifications of the steps described with exemplary method 302 can be used to provide still other exemplary methods of the present invention. After step 315, for example, steps 307, 310, and 315 could be repeated with successive additions of alkaline material until the desired pH level is achieved. Similarly, after step 335, steps 327, 330, and 335 could be repeated with successive additions of acidic material until the desired pH level is achieved.

For the exemplary methods previously described, a wash cycle using an alkaline fluid is followed by a wash cycle using an acidic fluid. Using the teachings disclosed herein, however, it will be understood that the order could be reversed to provide still other exemplary methods of the present invention as well.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a dishwasher appliance, the steps comprising:
providing fresh water W_{B} into a wash chamber of the dishwasher appliance;
dispensing an alkaline material to increase the pH of water W_{B};
spraying water W_{B} onto one or more articles in the wash chamber;
removing water W_{B} from the wash chamber;
providing fresh water W_{A} into the wash chamber;
dispensing an acidic material to decrease the pH of water W_{A};
spraying water W_{A} onto one or more articles in the wash chamber; and
removing water W_{A} from the wash chamber.

2. A method for operating a dishwasher appliance as in claim 1, further comprising the steps of:
providing fresh water W_{R} into the wash chamber; and,
spraying water W_{R} onto one or more articles in the wash chamber.

3. A method for operating a dishwasher appliance as in claim 2, further comprising the steps of heating water W_{R} after said step of providing fresh water W_{R} into the wash chamber.

4. A method for operating a dishwasher appliance as in claim 3, further comprising the steps of heating water W_{B} after said step of providing fresh water W_{B} into the wash chamber.

5. A method for operating a dishwasher appliance as in claim 1, wherein said step of dispensing an alkaline material comprises dispensing a predetermined amount of alkaline material.

6. A method for operating a dishwasher appliance as in claim 1, wherein said step of dispensing an alkaline material further comprises:
measuring the pH of water W_{B};
determining an amount of alkaline material to add to water W_{B} using the results of said step of measuring the pH of water W_{B}; and,
dispensing the amount of alkaline material from said step of determining.

7. A method for operating a dishwasher appliance as in claim 1, wherein said step of dispensing an acidic material further comprises:
measuring the pH of water W_{A};
determining an amount of acidic material to add to water W_{A} using the results of said step of measuring the pH of water W_{A}; and,
dispensing the amount of acidic material from said step of determining.

8. A method for operating a dishwasher appliance as in claim 1, wherein said step of dispensing an alkaline material increases the pH of water W_{B} to a pH value in the range of about 8 to about 12.

9. A method for operating a dishwasher appliance as in claim 1, wherein said step of dispensing an acidic material decreases the pH of water W_{A} to a pH value in the range of about 2 to about 5.

10. A method for operating a dishwasher appliance as in claim 1, measuring the turbidity of water W_{B} before said step of dispensing an alkaline material.

11. A method for operating a dishwasher appliance, the steps comprising:
providing a fresh water W_{P} into a wash chamber of the dishwasher appliance;
spraying water W_{P} onto one or more articles in the wash chamber;
measuring the turbidity of water W_{P} and, if the turbidity of water W_{P} is below a certain predetermined value T_{L}, then
providing fresh water W_{B} into a wash chamber of the dishwasher appliance;
dispensing an alkaline material to increase the pH of water W_{B};
spraying water W_{B} onto one or more articles in the wash chamber;
removing water W_{B} from the wash chamber;
providing fresh water W_{A} into the wash chamber;
dispensing an acidic material to decrease the pH of water W_{A};
spraying water W_{A} onto one or more articles in the wash chamber; and
removing water W_{A} from the wash chamber.

12. A method for operating a dishwasher appliance as in claim 11, further comprising the steps of:
providing fresh water W_{R} into the wash chamber; and,
spraying water W_{R} onto one or more articles in the wash chamber.

13. A method for operating a dishwasher appliance as in claim 12, further comprising the steps of heating water W_{R} after said step of providing fresh water W_{R} into the wash chamber.

14. A method for operating a dishwasher appliance as in claim 13, further comprising the steps of heating water W_{B} after said step of providing fresh water W_{B} into the wash chamber.

15. A method for operating a dishwasher appliance as in claim 1, wherein said step of dispensing an alkaline material comprises dispensing a predetermined amount of alkaline material.

16. A method for operating a dishwasher appliance as in claim 11, wherein said step of dispensing an alkaline material further comprises:
measuring the pH of water W_{B};
determining an amount of alkaline material to add to water W_{B} using the results of said step of measuring the pH of water W_{B}; and,
dispensing the amount of alkaline material from said step of determining.

17. A method for operating a dishwasher appliance as in claim 11, wherein said step of dispensing an acidic material further comprises:
measuring the pH of water W_{A};
determining an amount of acidic material to add to water W_{A} using the results of said step of measuring the pH of water W_{A}; and,
dispensing the amount of acidic material from said step of determining.

18. A dishwasher appliance, comprising
a wash chamber;
at least one spray assembly located in said wash chamber and configured for spraying fluids onto one or more articles located in said wash chamber;
at least one processing device configured for
executing a basic wash cycle using a wash fluid having an alkaline pH value;
executing an acid wash cycle using a wash fluid having an acidic pH value; and
executing a rinse cycle using fresh water.

19. A dishwasher appliance as in claim 18, further comprising:
a pH sensor in communication with said at least one processing device;
wherein said at least one processing device is further configured for
receiving one or more pH measurements from said pH sensor; and,
determining an amount of alkaline material to dispense using said one or more pH measurements.

20. A dishwasher appliance as in claim 18, wherein said at least one processing device is further configured for determining an amount of acidic material to dispense using said one or more pH measurements.
